(19) United States
(12) Patent Application Publication
(10) Pub. No.: US 2006/0262208 A1
(43) Pub. Date: Nov. 23, 2006

(54) Optical low pass filter and image pickup apparatus having the same

(76) Inventors: Nozomu Kitagishi, Utsunomiya-shi (JP); Hiroyuki Ohba, Sendai-shi (JP)

Correspondence Address: MORGAN & FINNEGAN, L.L.P., 3 WORLD FINANCIAL CENTER, NEW YORK, NY, 10281-2101, US

(21) Appl. No.: 11/432,040

(22) Filed: May 10, 2006

(30) Foreign Application Priority Data
May 12, 2005 (JP) 2005-139751

(51) Int. Cl. H04N 9/083

(52) U.S. Cl. 348/291

(57) ABSTRACT

An object is to provide an optical low pass filter that can achieve advantageous effects in spite of its simple structure, in reducing moire fringes and false color noise for a common subject that includes a two-dimensional pattern. An optical low pass filter according to the present invention includes a plane parallel plate composed of a biaxial crystal, wherein the plane parallel plate satisfies the condition 0°≦|θ|<20°, where θ is the angle formed by one of the optic axes of the biaxial crystal and the normal to the light incident surface.

### BACKGROUND OF THE INVENTION

1. Field of the Invention

The present invention relates to an optical low pass filter and an image pickup apparatus including the same. The present invention is preferably applied to an image pickup apparatus having an image pickup element including an array of regularly arranged pixels such as a digital single lens reflex camera, a digital still camera and a video camera, for example.

2. Related Background Art

In a digital single lens reflex camera, a digital still camera and a video camera or the like that uses a solid state image pickup element having an array of regularly arranged discrete pixels, false color noise and moire fringes are generated when an image of a subject having a periodical structure is taken in a state in which its period is equal to or closed to the period of the image pickup element. To prevent such false color noise and moire fringes from occurring, an optical low pass filter is conventionally provided in the optical system.

Optical low pass filters utilizing various optical principles such as ones utilizing birefringence of a crystal and ones utilizing a diffraction grating have been proposed. Among them, optical low pass filters that utilize birefringence of a uniaxial crystal are widely used as optical low pass filters that are advantageous in terms of MTF characteristics and uniformity in the low pass effect (see Japanese Patent Application Laid-Open Nos. 2001-147404 and H10-054960).

When one birefringent plate is used as a method of utilizing birefringence of crystal, it is not possible to displace an incident light beam more than one direction. Pattern images of subjects are generally extending in two dimensional directions, and therefore it is needed for the optical low pass filter to displace an incident light beam in multiple directions by using a plurality of crystal plates.

Besides the uniaxial crystals, use of biaxial crystals in optical low pass filters to prevent moire fringes from occurring has been known (see Japanese Patent Application Laid-Open No. 2004-246261).

Japanese Patent Application Laid-Open No. 2004-246261 discloses an optical low pass filter in which a biaxial crystal is used to form a double image thereby achieving the low pass effect.

In the case of an optical low pass filter that uses a uniaxial crystal, it is necessary to use a plurality of birefringent plates and phase plates etc. in order to improve false color noise and moire fringes in images of general subjects in which two dimensional patters exist.

Therefore, it is required to manufacture a plurality of birefringent plates through polishing, bonding, coating and other processes. This takes time and makes the manufacturing difficult. Furthermore, in the process of polishing/cutting or bonding of two or three crystal plates and the process of matching coating, defects and faults such as presence of dusts between the plates are likely to occur.

Japanese Patent Application Laid-Open No. 2004-246261 discloses an optical low pass filter that forms a double image using a biaxial crystal thereby providing the low pass effect.

However, Japanese Patent Application Laid-Open No. 2004-246261 discloses nothing about in what shape the biaxial crystal is to be formed to provide the low pass effect.

An object of the present invention is to provide an optical low pass filter that can achieve advantageous effects, in spite of its simple structure, in reducing moire fringes and false color noise for general subjects that include a two-dimensional pattern.

### SUMMARY OF THE INVENTION

An optical low pass filter according to the present invention includes a plane parallel plate composed of a biaxial crystal, wherein the plane parallel plate satisfies the condition 0°≦|θ|<20°, where θ is the angle formed by one of the optic axes of the biaxial crystal and the normal to the light incident surface.

An optical low pass filter according to another aspect of the present invention includes a plane parallel plate composed of a biaxial crystal, wherein in the plane parallel plate, the angle formed by one of the optic axes of the biaxial crystal and the normal to a light incident surface is designed in such a way that a light ray incident on the light incident surface emerges from the light emitting surface with ring-like shape.

### BRIEF DESCRIPTION OF THE DRAWINGS

FIG. 1 is a diagram schematically showing the structure of a single lens reflex camera relating to a first embodiment of the present invention.

FIG. 2 is a diagram showing the orientation of the optic axes of a biaxial crystal.

FIG. 3 illustrates an optical low pass filter composed of a biaxial crystal according to the first embodiment of the present invention.

FIGS. 4A, 4B and 4C show divergence of a light beam passing through the optical low pass filter according to the present invention.

FIGS. 5A, 5B and 5C show a linear image and MTF characteristics associated with the optical low pass filter according to the present invention.

FIG. 6 shows another embodiment of the present invention.

FIG. 7 shows another embodiment of the present invention.

### DESCRIPTION OF THE PREFERRED EMBODIMENTS

### First Embodiment

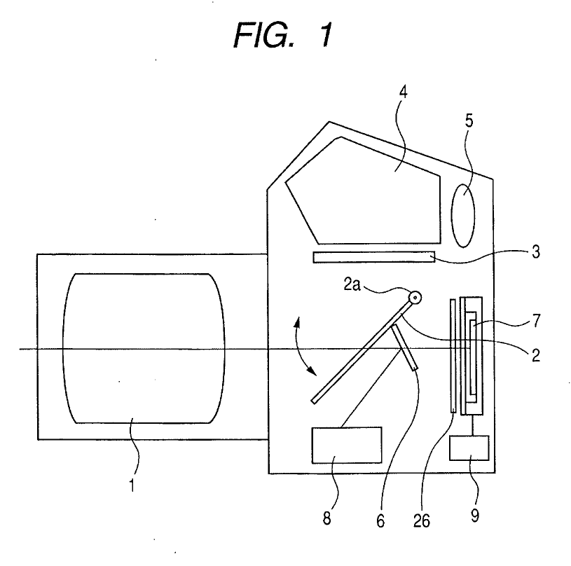

FIG. 1 schematically shows the relevant part of a digital single lens reflex camera having a photographing lens 1 in which an optical low pass filter according to the first embodiment of the present invention is included.

In FIG. 1, reference numeral 1 designates a photographing lens, reference numeral 2 designates a swing mirror (or a quick-return mirror) that can swing about the pivot shaft 2a and a part of which is configured as a half-mirror surface. Reference numeral 3 is a focusing screen (focus plate) on which an image of a subject is formed by the photographing lens 1. Reference numeral 4 is a pentaprism (penta roof prism as an image inverting member), which converts a subject image formed on the focusing screen 3 into an erected image.

Reference numeral 5 designates an eyepiece lens, which allows a viewer to view the subject image formed on the focusing screen 3 through the pentaprism 4. Reference numeral 6 designates a sub mirror fixedly attached on the swing mirror 2 and adapted to swing together with the swing mirror 2. Reference numeral 8 designates a focus detection device, which detects the focus state of the photographing lens 1 using a flux of light having been transmitted through the photographing lens 1, transmitted through a part of the swing mirror 2 and reflected by the sub mirror 6.

Reference numeral 26 designates a low pass filter composed of a biaxial crystal having a birefringent property through which an incident light beam is split by birefringence. Reference numeral 7 designates a solid state image pickup element. Reference numeral 9 designates an image processing portion that processes a signal from the solid state image pickup element 7 to provide image information.

In this embodiment, when a subject image is viewed through the viewfinder, an optical image transmitted through the photographing lens 1 is reflected by the swing mirror 2 and imaged on the focusing screen 3, and it is viewed through the pentaprism 4 and the eyepiece lens 5.

Focus detection for the photographing lens 1 is performed by processing an image transmitted through the semi-transparent mirror portion of the swing mirror 2, reflected by the sub mirror 6 downwardly in the mirror box and guided to the focus detection device 8.

On the other hand, upon photographing, the swing mirror 2 and the sub mirror 6 swing together and move out of the photographing-optical path. Natural light having passed through the photographing lens 1 is incident on the optical low pass filter 26 and emergent from the optical low pass filter 26 with desired image blur, and a subject image formed on the surface of the image pickup element 7 is picked up. The picked up image is converted into an electric signal. The electric signal is subjected to digital image processing in the image processing portion 9, and thereafter stored in a storage medium that is not shown in the drawings.

The optical low pass filter 26 used in the first embodiment is made of a biaxial crystal of Mg₂SiO₄ (forsterite) belonging to the orthorhombic system, by cutting substantially perpendicularly to one axis 24 among the two optic axes as shown in FIG. 3.

In the first embodiment, the angle θ formed by the one of the optic axes of the biaxial crystal and the normal to the light incident surface satisfies the following condition.
0°≦|θ|<20° (1)

It is more preferred that the numerical range of condition (1) be modified as follows.
0°≦|θ|<10° (1a)

Please note that the optical low pass filter 26 is a plane parallel plate. Therefore, if the one of the optic axes of the biaxial crystal and the normal to the light incident surface satisfy the above described condition regarding θ, the one of the optic axes of the biaxial crystal and the normal to the light emitting surface satisfy the same relationship.

In the optical low pass filter 26 in this embodiment, the degree of birefringence (selection of crystal) and the thickness of the crystal are determined in accordance with desired spatial frequency characteristics.

In the case where an image pickup optical system including the optical low pass filter 26 according to the first embodiment is applied to an image pickup apparatus having a solid state image pickup element composed of an array of regularly arranged pixels for converting a subject image into an electric signal, factors are designed to satisfy the following condition (2) concerning the relationship between the diameter pa of ring-like blur of the optical low pass filter 26 and the pixel pitch Pa of neighboring pixels of the image pickup element 7.
0.6<Pa/φa<1.8 (2)

In addition, in order to effectively suppress false color noise associated with Bayer pattern arrays in this embodiment, it is preferred that the diameter φa of ring-like blur be determined to satisfy the following condition.
0.6<Pa/φa<1.2 (2a)

Mg₂SiO₄ used in the optical low pass filter 26 according to the first embodiment is a silicate compound belonging to the orthorhombic system. It is used as a heat-resistant material or an insulating material etc. It is a thermochemically stable compound, and its natural crystal is also used as a jewel or the like.

The single crystal of this compound can be obtained for example by a method called Czochralski as disclosed in Journal of Crystal Growth vol. 23 (1974) pp. 121-124.

In the first embodiment also, a seed crystal cut in the <100> direction is used, and a single crystal is grown from an ingredient melt in which magnesium oxide (MgO) and silicon dioxide (SiO₂) are mixed and melt at a predetermined ratio.

Since the single crystal of Mg₂SiO₄ belongs to the orthorhombic system, its optical elasticity axes and crystal axes coincide with each other, the combination of which is shown in Table 1. In Table 1, the values of the refractive indices associated with the respective optical elasticity axes (Z, X and Y axes) are also presented.

TABLE 1

| | optical | |
|---|---|---|
| crystal axis | elasticity axis | refractive index |
| <100> (a axis) | Z axis | nz = 1.669 |
| <010> (b axis) | X axis | nx = 1.636 |
| <001> (c axis) | Y axis | ny = 1.650 |

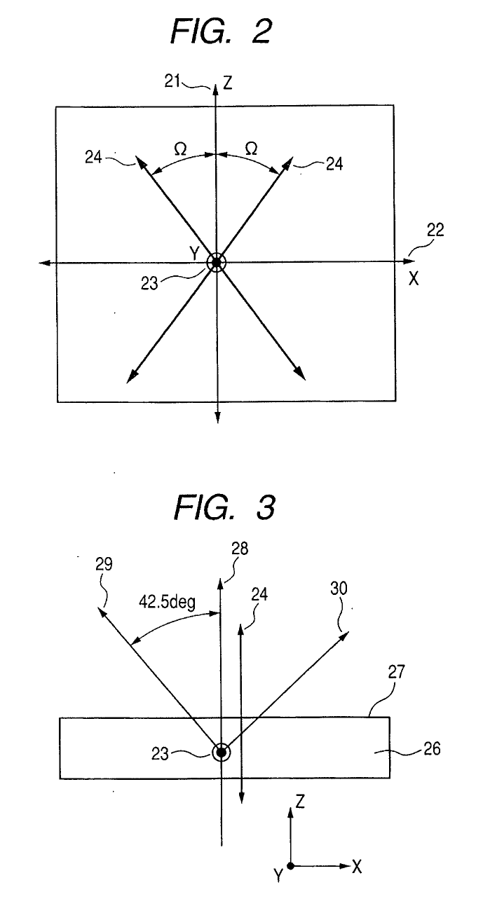

Since Mg₂SiO₄ crystal is a biaxial crystal, its optic axes are extending in two directions. FIG. 2 shows the relationship between the optical elasticity axes and the optic axes. The Z axis 21 and the X axis 22 lie in the plane of the drawing sheet of FIG. 2 and perpendicular to each other. The Y axis 23 is extending perpendicularly to the plane of the drawing sheet of FIG. 2.

The optic axes 24 are lying in the middle between the Z axis 21 and the X axis 22 in the plane including the Z axis 21 and the X axis 22. Here, the angle Ω formed by the Z axis 21 and the optic axis 24 is determined by the following formula:

$$tan Ω = \sqrt{\frac{{nz}^{2} ⨯ ( {ny}^{2} - {nx}^{2} )}{{nx}^{2} ⨯ ( {nz}^{2} - {ny}^{2} )}}$$

where nx, ny and nz are the refractive indices in the X, Y and Z axis directions respectively.

Substituting the values of the refractive indices, nx=1.636, ny=1.650 and nz=1.699 into the above formula gives an angle Ω of 41 degrees.

The inventors of the present invention produced a plane parallel plate whose surface normal was lying between the Z axis 21 and the X axis 22 and forming an angle of 41° with the Z axis 21 by cutting an Mg₂SiO₄ crystal formed by the aforementioned Czochralski method and determined the angle Ω formed by the optic axis 24 and the Z axis 21 by observing an conoscope image using a transmission optical microscope. The determined angle Ω was 42.5±1°. In view of this, in this embodiment, the angle Ω formed by the optic axis 24 and the Z axis 21 was assumed to be 42.5° and the plane parallel plate was cut out in such a way that the normal to the light incidence surface coincides with the optic axis 24.

In actual cutting of the plane parallel plate, the a axis <100>, the b axis <010> and the c axis <001> in the sample were determined by the use of a generally used X-ray diffraction apparatus, and the directions of the optic axes were determined based on the relationship between the optical elasticity axis and the crystal axis shown in Table 1.

FIG. 3 shows the crystal orientation in the optical low pass filter 26 in the form of a plane parallel plate made of an Mg₂SiO₄ crystal cut out in the above described manner. The normal 28 to the incidence surface 27 of the optical low pass filter 26 forms an angle of 42.5° with the a axis 29 or the Z axis, and is parallel to the optic axis 24.

The C axis (the Y axis) 23 is oriented in such a way as to be parallel to the incidence surface 27 and perpendicular to both the normal 28 to the incidence surface 27 and the a axis 29.

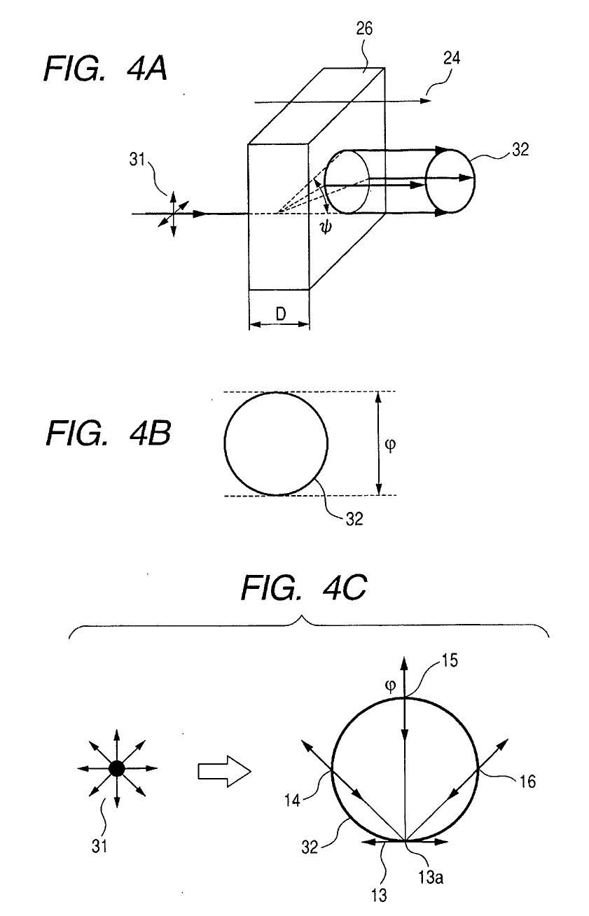

When natural light perpendicular to the incidence surface 27 or parallel to the optic axis 24 is incident on the plane parallel plate made of an Mg₂SiO₄ crystal cut out as described above, the exit light takes a form of a hollow cylinder due to internal conic refraction. Referring to FIGS. 4A, 4B and 4C, natural light 31 incident on the optical low pass filter 26 made of an Mg₂SiO₄ crystal along the direction parallel to the optic axis 24 diverges conically at an angle of Ψ in the interior of the crystal of the optical low pass filter 26, and exits out of it as emergent light 32 having a hollow cylindrical shape.

FIG. 4B shows the emergent light 32 in a cross section perpendicular to the direction in which the light travels. The cross section of the emergent light 32 is of a ring-like shape whose diameter φ is of a dimension determined by the thickness d of the optical low pass filter 26 constituted by the plane parallel plate and the angle of divergence Ψ in the interior of the crystal.

Here, the relationship among the angle of divergence Ψ, the thickness d of the optical low pass filter 26 and the diameter φ of the ring-shape can be formulated as follows.
φ=d×tan Ψ (a)

The angle of divergence Ψ of the cone can be determined by the following formula:

$$tan Ψ = \sqrt{\frac{( {ny}^{2} - {nx}^{2} ) ⨯ ( {nz}^{2} - {ny}^{2} )}{{nx}^{2} ⨯ {nz}^{2}}} \qquad ( 3 )$$

where nx, ny and nz are the refractive indices of the Mg₂SiO₄ crystal.

With the values of the refractive indices nx=1.636, ny=1.650 and nz=1.669, the value of tan Ψ is 0.02. We actually prepared low pass filters that have different thicknesses and in which the normal to the incident surface is parallel to the optic axis by cutting them out from an Mg₂SiO₄ crystal using the above mentioned means, and measured the diameter φ of the ring-shape of the transmitted light. The results are shown in Table 2 presented below. As will be apparent from FIG. 2, it was found that the result obtained from formula (3) and the values obtained by the actual measurement coincide with each other.

As shown in FIG. 4C, blur that occurs when natural light 31 passes through a biaxial crystal that has been cut substantially perpendicularly to the optic axis 24 is ring-like blur 32 caused by internal conic refraction, and the polarization direction at various positions in the ring-like blur are as follows.

The beam portion that has traveled straightly on the line of the incident light beam without being refracted at the surface of the crystal has a polarization component in the direction indicated by arrow 13. In other words, it has the polarization plane perpendicular to the plane of the drawing sheet of FIG. 4C. The light beam portion remotest from the above mentioned beam portion has a polarization component in the direction indicated by arrow 15 that is perpendicular to the direction of arrow 13. Namely, it has the polarization plane parallel to the plane of the drawing sheet of FIG. 4C. At other positions, beams have polarization components in the directions indicated by arrows 14 and 16. The direction of their polarization planes coincide with the directions of lines that intersect beam position 13a.

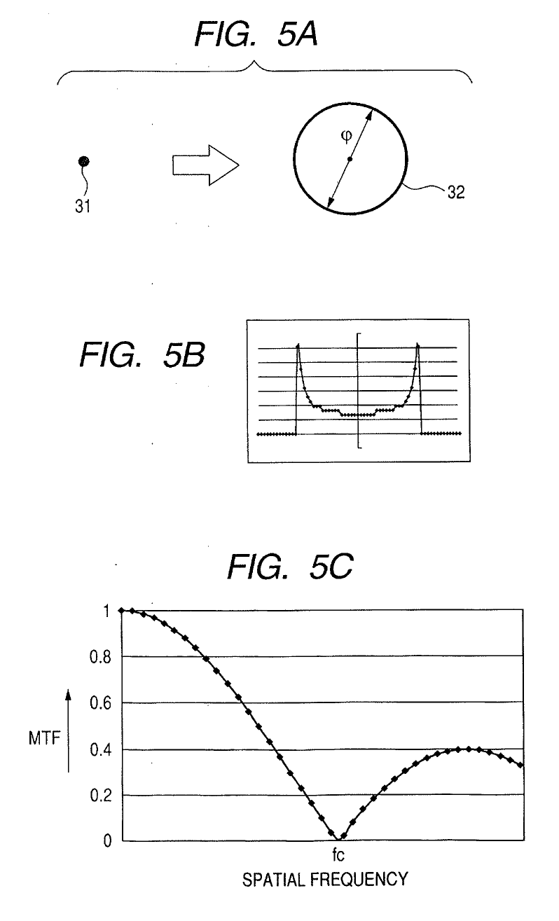

It is known that in discretely separated optical low pass filters such as conventional four point separation optical low pass filters that separate incident light beam into four directions, there exists a trap point fc at which the MTF becomes zero at a certain spatial frequency. In view of this, how the spatial frequency characteristic of the MTF is like in the case of ring-like blur caused by internal conic refraction in this embodiment will be discussed below with reference to FIGS. 5A, 5B and 5C.

As shown in FIG. 5A, when natural light 31 passes through a biaxial crystal (see FIGS. 4A, 4B and 4C) that has been cut substantially perpendicularly to the optic axis, ring-like blur 32 occurs due to internal conic refraction. Here, the diameter of the ring-like blur 32 is represented by φ. FIG. 5B shows the linear image intensity distribution-along a line including a diameter. It has peaks at positions near the ring portion having diameter φ of the ring-like blur 32, and the line spread function has a U-shape with a wide bottom.

FIG. 5C shows the MTF of the optical low pass filter according to the first embodiment. It was discovered that a trap point fc at which the MTF becomes zero at a certain spatial frequency also exists in the optical low pass filter that causes ring-like blur like the filter according to this embodiment. However, while in conventional cases the relationship between the separation width Δ in discrete separation and the trap point fc is formulated as fc=1/(2·Δ), in the case of ring-like blur 32 caused by internal conic refraction in the first embodiment, the relationship between the diameter φ of the ring-like blur and the trap point fc is formulated as fc=1.52/(2·φ).

To achieve a low pass effect, the degree of birefringence (selection of crystal) and the thickness of the crystal should be determined in accordance with this formula.

Based on the above discovery, in the first embodiment, a ring diameter of 9.9 μm is determined for an optical low pass filter for use in a Bayer pattern image pickup element having a pixel pitch of 9 μm. The thickness d of the crystal required for providing a ring diameter of 9.9 μm given by substituting 0.02 for tan Ψ in formula (a) is 495 μm.

TABLE 2

| crystal thickness | ring diameter | |
|---|---|---|
| (μm) | (μm) | tanΨ measured |
| 2581 | 51.4 | 0.0199 |
| 3257 | 65.6 | 0.0201 |

In the case of ring-like blur caused by internal conic refraction like that in the first embodiment, the false color reduction effect and resolutions are uniform in the upward, downward, right, left and oblique directions. With the optical low pass filter according to the first embodiment, it is possible to obtain natural images having improved symmetry and uniformity as compared to conventional separation type optical low pass filters using a plurality of uniaxial crystals.

In addition, in the optical low pass filter according to the first embodiment, re-rising of the MTF of the low pass filter (LPF) in the spatial frequency range higher than the cutoff frequency is more moderate than in the case of conventional separation type optical low pass filters using a plurality of uniaxial crystals, and the optical low pass filter according to the first embodiment has a superior false color reduction effect accordingly.

The optical low pass filter according the first embodiment is configured as a plane parallel plate 26 made of a biaxial crystal that has been cut in such a way that the surface normal 28 substantially coincides with one of the optic axes 24 of the biaxial crystal. By utilizing internal conic refraction, an optical low pass filter that can achieve the two-dimensional false color reduction effect is realized by the simplest structure in the form of one crystal plate.

Since the optical low pass filter according to this embodiment is composed of a single crystal plate, it can be produced more easily as compared to conventional optical low pass filters having a complex structure that needs a plurality of crystal plates such as a birefringent plate and a phase plate, which require a long processing time.

In the case where a plurality of crystal plates are used, they frequently become defective due to dusts, scratches and defects produced in the process of polishing, cutting, matching coating and bonding. In contrast, the optical low pass filter according to this embodiment suffers from less dusts, scratches and defects, since it is composed of a single crystal plate. Therefore, an excellent optical low pass filter can be obtained easily.

The crystal used in the optical low pass filter according to this embodiment is not limited to Mg₂SiO₄ (forsterite), but other transparent biaxial crystals belonging to the orthorhombic system, the monoclinic system or the triclinic system can also achieve similar effects.

For example, tridymite (SiO₂), mica (KAl₂(AlSi₃O₁₀) (OH)₂), chrysoberyl (BeAl₂O₄), aragonite (CaO.CO₃) fluorine type topaz (Al₂SiO₄(F)₂) and gypsum (CaSO₄.2H₂O) may also be used.

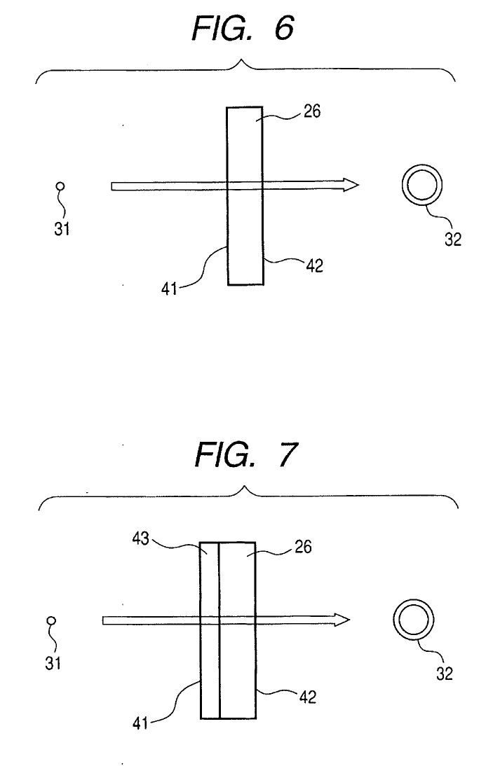

In the case where the optical low pass filter is used in a digital camera, it is advantageous in saving space and enhancing strength that an infrared block coating 41 be applied on a surface of the optical low pass filter 26 as shown in FIG. 6, or that an infrared absorption filter 43 be bonded on the front (or rear) side of the optical low pass filter 26 as shown in FIG. 7. In this connection, reference numeral 42 in these drawing designates anti-reflection coating.

The optical low pass filter according to the first embodiment may be used not only in a digital single lens reflex camera but also in a digital camera that uses an image pickup element having regularly arranged pixels such as a compact digital camera, a video camera, a camera built in a cellular phone, a digital camera for industrial/measurement use and a board camera, while achieving similar advantageous effects.

As per the above, by constructing an optical low pass filter as a plane parallel plate made of a biaxial crystal that is cut in such a way that the surface normal thereto coincides with one of the optic axes of the biaxial crystal to make use of internal conic refraction, the following advantages effects are achieved:

An optical low pass filter having a two-dimensional false color reduction effect can be realized with a simple structure in the form of one crystal plate;

The low pass filter can be produced more easily as compared to conventional low pass filters that need a plurality of crystal plates such as a birefringent plate and a phase plate and requires a long processing time;

Since the optical low pass filter is composed of a single crystal plate, it suffers from less dusts, scratches and defects as compared to the optical low pass filter composed of a plurality of crystal plates which may frequently become defective due to dusts, scratches and defects produced in the process of polishing, cutting, matching coating and bonding, and it is possible to obtain an excellent optical low pass filter;

The optical low pass filter has excellent uniformity and symmetry with respect to the vertical and horizontal directions in terms of false color reduction effect and resolution, and accordingly it can provide natural images; and

Rising of the MTF of the optical low pass filter in the spatial frequency range higher than the cutoff frequency is more moderate than in four point separation type optical low pass filters, and it has a superior false color reduction effect.

This application claims priority from Japanese Patent Application No. 2005-139751 filed May 12, 2005, which is hereby incorporated by reference herein.

What is claimed is:

1. An optical low pass filter comprising a plane parallel plate composed of a biaxial crystal,
wherein the p-lane parallel plate satisfies the following condition concerning the angle θ formed by one of the optic axes of the biaxial crystal and the normal to a light incident surface:
0°≦|θ|<20°.

2. An optical low pass filter according to claim 1, wherein the material constituting the biaxial crystal is Mg₂SiO₄.

3. An image pickup apparatus comprising:
an image pickup optical system including an optical low pass filter according to claim 1 provided in its optical path; and
a solid state image pickup element including an array of regularly arranged pixels for converting an image of a subject formed by the image pickup optical system into an electric signal.

4. An image pickup apparatus according to claim 3, wherein the following condition is satisfied:
0.6<Pa/φa<1.8
where Pa is a pixel pitch of neighboring pixels of the solid state image pickup element, and φa is a diameter of ring-like blur generated when natural light enters into and then emerges from the optical low pass filter.

5. An optical low pass filter comprising a plane parallel plate composed of a biaxial crystal, wherein in the plane parallel plate, the angle formed by one of the optic axes of the biaxial crystal and the normal to a light incident surface is designed in such a way that a light ray incident on a light incident surface emerges from the light emitting surface with ring-like shape.

6. An optical low pass filter according to claim 5, wherein the material constituting the biaxial crystal is Mg₂SiO₄.

7. An image pickup apparatus comprising:
an image pickup optical system including an optical low pass filter according to claim 5 provided in its optical path; and
a solid state image pickup element including an array of regularly arranged pixels for converting an image of a subject formed by the image pickup optical system into an electric signal.

8. An image pickup apparatus according to claim 7, wherein the following condition is satisfied:
0.6<Pa/φa<1.8
where Pa is a pixel pitch of neighboring pixels of the solid state image pickup element, and φa is a diameter of ring-like blur generated when natural light enters into and then emerges from said optical low pass filter.
